(19) United States
(12) Patent Application Publication
(10) Pub. No.: US 2015/0011682 A1
(43) Pub. Date: Jan. 8, 2015

(54) CEMENT COMPOSITION

(71) Applicant: Van Dyke Garner, Mesa, AZ (US)

(72) Inventor: Van Dyke Garner, Mesa, AZ (US)

(21) Appl. No.: 14/222,371

(22) Filed: Mar. 21, 2014

(30) Foreign Application Priority Data
Jul. 2, 2013 (AU) 2013902449
Dec. 12, 2013 (AU) 2013905028
Jan. 14, 2014 (AU) 2014200207

(51) Int. Cl. C04B 24/26; C04B 24/04; C04B 7/00; C04B 24/20

(52) U.S. Cl. CPC C04B 24/2652; C04B 24/20; C04B 24/04; C04B 7/00; C04B 24/2611
USPC 524/5; 524/161; 524/400; 524/8; 524/2

(57) ABSTRACT

Lime-free admixture compositions comprise a combination of emulsifiers, toughening resins/plasticizers, adhesive resins, pumping aids for providing lubrication, rheology controllers, water retention agents, water repellents/overcoat finishes, accelerators, water reducers and air entraining agents. The lime-free admixture compositions are total replacements for lime. The lime-free admixture compositions are non-corrosive, making them safe to use by workers and they have rheological properties that make them suitable for use in various applications including concrete, mortars, grouts and stuccos (renders).

This Application claims the benefit of priority to Australian Patent Application Serial No. 2014200207, filed on Jan. 14, 2014, which also claims priority to Australian Provisional Patent Application Serial No. 2013905028, filed Dec. 12, 2013, and to Australian Provisional Patent Application Serial No. 2013902449, filed Jul. 2, 2013, all of which are incorporated herein by reference in their entirety.

### 1. FIELD OF THE INVENTION

This invention relates generally to hydraulic cement admixtures and more specifically to lime-free admixture compositions for hydraulic cements and methods thereof.

### 2. BACKGROUND OF THE INVENTION

An admixture is a formulated composition other than a hydraulic cement (or binder), water and aggregates (such as sand and stones) that is used as an ingredient to control setting and early hardening, workability, or to provide additional cementing properties when making hardened binders (e.g., concrete, mortar, stucco (render) or grout). Examples of binders, which are hydraulic cements, include Portland cement, or in combination with gypsum, aluminous cement and pozzolanic cement. Typically, an admixture is added to a batch of a binder immediately before or during mixing with water. Admixtures have generally been used to modify the properties of a binder so that it is more suitable for a particular purpose such as better handling characteristics during processing or for economic reasons. Generally admixtures are provided as single functionality additives that are added to improve a particular property of a hardened binder. Admixtures have been used to achieve certain structural improvements in hardened binders; improved quality of binders through the successive stages of mixing, transporting, applying and hardening of binders; improved processing characteristics especially in emergency situations during binder operations; and in cost reduction.

Admixtures have been available as water-soluble solids or powders that are mixed at the point of usage, or as ready-to-use liquids that are added at bulk blending locations. It has been desirable to provide pre-weighed quantities of admixtures so that the expected properties and performance of the binder batch are met. Small deviations from the recommended level of admixture to binder have been known to deteriorate the properties of the hardened binder, so it is desirable to have admixture compositions that are more forgiving in terms of admixture to binder ratio.

Pre-mixed blends of binder and admixture have been used. They require large quantities of the pre-mixed blends to be transported. It is preferable to be able to add a small quantity of an admixture to a commonly available binder, which is then hardened at a job site.

Even though there are a number of commercial powder and liquid admixtures, many of them have been based on lime-containing blends when used with binders. During handling the use of lime-containing blends has been deleterious to the health of workers. In addition, some lime-free admixtures have been found to provide inadequate weathering and strength properties to hardened binders, as well as inadequate handling characteristics during the processing of a mixture of admixture, binder, aggregates and water.

For the foregoing reasons, a need exists to provide improved lime-free admixture compositions for hydraulic cements and methods thereof. Such compositions must be safe and effective for use by workers and their method of use should preferably be easy to understand, routine and readily adopted. The inventor of this application has discovered admixture compositions and methods for hydraulic cements that meet these needs.

The contents of U.S. Pat. No. 7,625,960 are incorporated herein by reference.

### 3. SUMMARY OF THE INVENTION

It is an object of the present disclosure to provide improved lime-free admixture compositions for hydraulic cements.

It is a further object of the present disclosure to provide improved lime-free admixture compositions for hydraulic cements particularly suitable for making mortar and stucco (render) mixtures.

It is a still further object of the present disclosure to provide improved lime-free admixture compositions for hydraulic cements particularly suitable for making stucco (render) mixtures having rheological properties suitable for applying stucco (render) to non-wire mesh wrapped expanded polystyrene substrates.

It is a further object of the present disclosure to provide improved lime-free admixture compositions for hydraulic cements that are biodegradable and safe to use.

It is another object of the present technology to provide improved lime-free admixture compositions for hydraulic cements that require less water and are suitable for hot, dry climates.

It is a yet further object of the present disclosure to provide methods for using improved lime-free admixture compositions for hydraulic cements to make improved masonry compositions including concretes, mortars, stuccos (renders) and grouts.

### 4. BRIEF DESCRIPTION OF THE PREFERRED EMBODIMENTS

In accordance with one embodiment of the present invention, a lime-free admixture composition for hydraulic cement is disclosed. The lime-free admixture composition comprises, in combination about 0.238 pounds (107.95 grams) to about 0.322 pounds (146.06 grams) of a sodium dodecyl benzene sulfonate emulsifier, 0.051 pounds (23.133 grams) to about 0.069 pounds (31.298 grams) of a dicumyl peroxide emulsifier, or about 0.289 pounds (131.09 grams) to about 0.391 pounds (177.35 grams) of the combination of both of the emulsifiers per 1600 pounds (725.748 kilograms) of hydraulic cement, about 1.012 pounds (459.04 grams) to about 1.369 pounds (620.97 grams) of a plurality of toughening resins per 1600 pounds (725.748 kilograms) of hydraulic cement; said toughening resins being an isoprene polymer rubber and a vinyl acetate/vinyl versatate polymer in combination, the combination of both toughening resins being the preferred since neither the isoprene polymer rubber nor the vinyl acetate/vinyl versatate polymer acting singularly can produce the desired effect, emulsified singularly by either the sodium dodecyl benzene sulfonate emulsifier or the dicumyl peroxide emulsifier or by the combination of both emulsifiers, the combination of both emulsifiers being the preferred, and about 11.56 pounds (5.2435 kilograms) to about 15.64 pounds (7.0942 kilograms) of a plurality of accelerators, calcium formate being the preferred, per 1600 pounds (725.748 kilograms) of hydraulic cement, and about 1.156 pounds (524.35 grams) to about 1.564 pounds (709.42 grams) of a plurality of water retention/water reduction agents, sodium gluconate being the preferred, per 1600 pounds (725.748 kilograms) of hydraulic cement, for hardening a mixture comprising hydraulic cement, a plurality of aggregates, water and the lime-free admixture composition.

In accordance with a second embodiment of the present invention, a lime-free admixture composition for hydraulic cement is disclosed. The lime-free admixture composition comprises, in combination a plurality of emulsifiers, a plurality of toughening resins emulsified by the plurality of emulsifiers and a plurality of accelerators for hardening a mixture comprising hydraulic cement, a plurality of aggregates, water and the lime-free admixture composition.

In accordance with a third embodiment of the present invention, a method for using lime-free admixture compositions to make masonry compositions is disclosed. The method comprises the steps of providing a plurality of emulsifiers, a plurality of toughening resins emulsified by the plurality of emulsifiers and a plurality of retarders and accelerators for hardening a mixture comprising hydraulic cement, a plurality of aggregates, water and the lime-free admixture composition. The method further comprises the steps of adding a first quantity of water into a mixer; blending a quantity of hydraulic cement with the water in the mixer; blending a quantity of the lime-free admixture composition into the water and hydraulic cement in the mixer; blending a first quantity of a plurality of aggregates into the water, hydraulic cement and the lime-free admixture composition in the mixer; blending a second quantity of water to the mixer; blending a second plurality of aggregates to the mixer and mixing the mixture comprising water, the hydraulic cement, the admixture composition and the plurality of aggregates in the mixer for a period of time of not less than about 6.5 minutes.

The foregoing and other objects, features, and advantages of the invention will be apparent from the following, more particular description of the preferred embodiments of the invention.

### 5. DETAILED DESCRIPTION OF THE PREFERRED EMBODIMENTS

The lime-free admixture compositions of the present disclosure comprise a combination of ingredients. The lime-free admixture compositions are 100% replacements for lime. The ingredients of the lime-free admixture compositions have specific purposes that lead to optimized properties when used in combination with a binder.

The lime-free admixture compositions of the present disclosure provide certain performance benefits over lime-free admixtures disclosed in U.S. Pat. No. 7,625,960. In particular the admixtures of the present invention perform better, particularly as stuccos/renders or mortars in dry or hot climates and are sufficiently versatile enough to work equally effective in colder climates to the point of freezing.

They provide greater resistance to cracking, adhere better and directly onto polystyrene and etched steel substrates. When used with newly disclosed more powerful water retention/water reduction agents in hydrating identical Portland cement mixtures the newly disclosed formulation reduces water consumption by 17% to 22.5% when compared to the admixtures disclosed in U.S. Pat. No. 7,625,960, the contents of which are incorporated herein by reference.

In this description a binder is a hydraulic cement of the type noted supra, that is at least gypsum, Portland cement, aluminous cement and pozzolanic (fly ash) cement and combinations thereof. Various grades of the binder may be effectively used with lime-free admixture compositions of this disclosure. For example Portland cement is available as Type I-V. It is understood that mixtures of binders may also be used with the lime-free admixture compositions. In addition, various aggregates may be used with lime-free admixture and binder mixtures. Aggregates include various grades of fillers, sands and rocks commonly used in the construction industry.

The lime-free admixture compositions of this disclosure are dry powders suitable for facile transportation. They are not hygroscopic, and therefore do not entrain moisture or mold during transportation. The lime-free admixture compositions readily mix with binders and form suitable slurries when water is added. In comparison to liquid admixtures, lime-free admixture compositions provide more coverage resulting in less cost per volume of material used, no spoilage, no considerations due to weather conditions, such as freezing temperatures, less need for storage space and lower freight costs.

The lime-free admixture compositions of this disclosure are preferably non-corrosive, making them safe to use by workers and they have rheological properties that make them suitable for use in various applications. The surfactants and the emulsifiers of the lime-free admixture compositions of this disclosure are biodegradable.

The lime-free admixture compositions of this disclosure are capable of providing higher compressive strength, greater toughness leading to less crack formation and less shrinkage, reduced water consumption, greater color fastness and no leaching of ingredients in comparison to lime containing admixtures. When a hardened binder is painted, the lime-free admixture compositions do not burn-out, that is, because there is no lime in lime-free admixture compositions, migration of lime between the hardened binder and the paint is avoided. In comparison, lime-containing admixtures darken paint because of chemical reactions of lime and the paint.

In the specific case of stucco (render) finishes, it is usual practice to apply the stucco (render) binder over a wire mesh and expanded polystyrene substrates, which is mounted on a building frame. Since the wire mesh may corrode, the oxidative corrosion products of the wire mesh may discolor the stucco (render). The lime-free admixture compositions of this disclosure have no corroding ingredients. In addition, the mixture of lime-free admixture composition added to binder, water and aggregates may be applied directly to etched steel and non-wire mesh wrapped expanded polystyrene substrates because of their enhanced adhesive and rheological properties, providing a considerable savings in cost of construction.

The lime-free admixture compositions of the present disclosure have extended shelf-lives because they are powders in which the ingredients do not react with one another until activated by water and the binder. The lime-free admixture compositions comprise ingredients that are controlled released for controlled speed of reaction when added to binder and water.

The ingredients of the lime-free admixture compositions of the present disclosure comprise a combination of emulsifiers, toughening resins, adhesive resins, pumping aids for providing lubrication, rheology controllers, water retention agents, water repellents, overcoat finishes, accelerators, water reducers and air entraining agents. Toughening resins may also be plasticizers. An effective lime-free admixture composition comprises at least a combination of a plurality of emulsifiers, a plurality of toughening resins and a plurality of accelerators. The lime-free admixture compositions of this disclosure are environmentally friendly because none of the ingredients contain lime, phosphates, phenols, volatile organic compounds, nitrates or nitrites. The combination of ingredients of lime-free admixture compositions synergistically provides optimum performance when used with a binder and water.

Some emulsifiers (or hydrotopes) used in the lime-free admixture compositions of the present disclosure include both dicumyl peroxide and anionic surfactants such as a plurality of linear alkyl benzene sulfonate salts of an alkali earth metal cation of the Group I and II elements (including, but not limited to lithium, sodium, potassium, magnesium and calcium). These may be used individually or in combination. Also usable are a plurality of linear alkyl benzene sulfonate salts of a non-metal cation (including, but not limited to ammonium, alkyl ammonium, aryl ammonium, pyridine, pyrrole and piperidine and derivatives of alkyl ammonium, derivatives of aryl ammonium, derivatives of pyridine, derivatives of pyrrole and derivatives of piperidine). Emulsifiers are used for a variety of purposes including their ability to carry organic chemicals into water to make solutions. CALSOFT® F-90 manufactured by Pilot Chemical Co., CA, U.S.A., NORFOX® 90 manufactured by Norman, Fox & Co., CA, U.S.A., and WITCONATE® 90 FLAKE, manufactured by Witco Corp., CA, U.S.A. are examples of a sodium salt of dodecyl benzene sulfonate available as a biodegradable solid. An example of a non-ionic emulsifier comprising a mixture of alkyl aryl polyethoxylates, compounded silicone and linear alcohol (CA Reg. No. 2935-50142) suitable for use in lime-free admixture compositions is R-11® SPREADER ACTIVATOR, manufactured by Wilbur-Ellis Co., CA, U.S.A. It is understood that other biodegradable surfactants including cationic, amphoteric and non-ionic surfactants that can act as emulsifiers of organic polymers into water are equivalents that can be used in lime-free admixture compositions. A plurality of linear alkyl benzene sulfonate salts of an alkali earth metal cation and a plurality of linear alkyl benzene sulfonate salts of a non-metal cation, and a plurality of linear alkyl benzene sulfonate salts of alkali earth metal cation and a plurality of linear alkyl benzene sulfonate salts of non-metal cation are most preferred emulsifiers because of their biodegradability. It is understood that biodegradable emulsifiers are most preferred.

Some toughening resins used in lime-free admixture compositions of this disclosure include rubbers such as isoprene polymer rubbers, isoprene copolymer rubbers and styrene/butadiene/styrene (hereinafter denoted SBS) copolymer rubbers, as well as water redispersible polymers such as ethylene/vinyl acetate (hereinafter denoted EVA) copolymers and vinyl acetate/vinyl versatate (hereinafter denoted VA/VV) copolymers. These polymers are thermoplastic materials. The toughening function of these polymers prevents crack growth and shock resistance during and after hardening of the binder and improves abrasion resistance, flexibility and impact resistance in the otherwise brittle binder matrix. The rubbers used in lime-free admixture compositions are in the form of solid crumbs. Granulated crumb form is preferred. Further, it is preferred to use a crumb size corresponding to size 16 mesh sand. This makes for easier dispersion of the rubbers with the above-mentioned emulsifiers in lime-free admixture compositions. SEPTON® 4033 manufactured by Kurary America, Inc., NY, U.S.A. is an example of an isoprene polymer rubber suitable as a toughening resin for lime-free admixture compositions. VECTOR® 2411, manufactured by Exxon Mobil is an example of a SBS copolymer rubber suitable for use as a toughening resin for lime-free admixture compositions. NIPOL® 1401LG (a nitrile polymer rubber crumb), manufactured by Zeon Chemicals, KY, U.S.A. is another example of a rubber suitable for use in lime-free admixture compositions. Mixtures of various rubbers may also be used as toughening resins. It is understood that other rubbers and mixtures having different chemical compositions than those described supra may also be used as equivalents in lime-free admixture compositions. Isoprene polymer rubbers, isoprene copolymer rubbers and SBS copolymers in crumb form when emulsified with a sodium dodecyl benzene sulfonate emulsifier or a dicumyl peroxide emulsifier or by the combination of both emulsifiers, are the preferred rubbers in lime-free admixture compositions.

In order to avoid confusion with any trademark terms, the term vinyl versatate (VV) for purposes of this patent is defined to have the following meaning. VV means a vinyl ester of mixed length carbon chains, wherein the carbon chains include a mixture of C9 to C11 lengths.

VA/VV copolymers and EVA copolymers are available as specially coated latex powders that are redispersible in water and have irreversible film-forming properties after water is removed in formulations made with these copolymers. Examples of VA/VV copolymers suitable for use in lime-free admixture compositions of this disclosure include AXILAT PAV 29 manufactured by MomentiveTM Specialty chemicals, France SAS and DOW DLP 120, manufactured by Dow Chemical, MI, U.S.A. is a preferred VA/VV copolymer. Examples of EVA copolymers suitable for use in lime-free admixture compositions include VINNAPAS® RP 140, VINNAPAS® RP 245 and VINNAPAS® RE 5010 N, manufactured by Wacker Polymer Systems LP, MI, U.S.A., DOW DLP 214, manufactured by Dow Chemical, MI, U.S.A and ELVACE® 4085, manufactured by Forbo Adhesives Synthetic Polymers, IL, U.S.A. Combinations of polyvinyl acetate (hereinafter denoted PVA) polymers and copolymers such as DYNO-BOND manufactured by Dyno-Bond, Inc., ON, Canada are also available as specially coated latex powders that are redispersible in water “once only”, and are suitable for use in lime-free admixture compositions. It is understood that other redispersible copolymers are suitable for use in lime-free admixture compositions. One example of an alternative redispersible copolymer is VINNAPAS® RI 554 Z (a copolymer of ethylene/vinyl chloride/vinyl laurate), manufactured by Wacker Polymer Systems LP, MI, U.S.A.

Isoprene polymer rubbers, isoprene copolymer rubbers, SBS copolymer rubbers, VA/VV copolymers, EVA copolymers, PVA polymers and PVA copolymers also act as adhesives in lime-free admixture compositions of this disclosure. These ingredients promote enhanced adhesion of the binder, water, aggregates and lime-free admixture composition mixtures to substrates such as wire mesh/expanded polystyrene substrates and non-wire meshed/expanded polystyrene substrates as discussed supra in stucco (render) applications of lime-free admixture compositions, as well as for adhering to masonry and wooden building structures. It is understood that a combination of ingredients are used in lime-free admixture compositions.

Pumping aids for controlling rheology and providing lubricity may be ingredients in the lime-free admixture compositions of this disclosure. Pumping aids are particularly important when a mixture of the binder, water, aggregates and the lime-free admixture composition is applied by spray pumping or during the transfer of smaller batches of the mixture from a larger batch using pumping apparatus.

Pumping aids thicken the mixture of binder, water, aggregates and the lime-free admixture compositions, increasing the viscosity, thereby reducing de-watering of the mixture during the pumping process. Some pumping aids include polyethylene oxide polymers (e.g. POLYOX® WSR-301, having a viscosity in a 1% aqueous solution at 25.degree. C. of 1650-5500 mPa.multidot.s manufactured by Dow Chemical, MI, U.S.A.), hydroxypropyl methyl cellulose polymers (e.g. METHOCEL® 240, manufactured by Dow Chemical Co., MI, U.S.A. and HPMC MECELLOSE.RTM., manufactured by Samsung Fine Chemical, Ltd., Korea) and hydroxyethyl methyl cellulose polymers (HEMC MECELLOSE.RTM., manufactured by Samsung Fine Chemical, Ltd., Korea). It is understood that there are many other suitable pumping aids for lime-free admixture compositions including, but not limited to polyethylene glycol polymers and copolymers, polyacrylamide polymers and copolymers, xanthan gums and guar gums and their derivatives. The combination of polyethylene glycol polymers and guar gums and their derivatives are the preferred pumping aids for controlling rheology and providing lubricity for pumping a mixture of the binder, water, aggregates and the lime-free admixture compositions.

The pumping aids and toughening resins described supra also act as water retention agents. Water retention agents reduce the amount of water that is added to the lime-free admixture composition, binder and aggregates mixture, thereby decreasing shrinkage and enhancing strength of the hardened binder.

In the specific case of stucco (render) applications it is common to apply paint finish over the hardened stucco (render) acting as both water repellent and final overcoat finish. The lime-free admixture compositions of this disclosure include ingredients that provide water repellency and an overcoat finish in-situ when a mixture of the binder, water, aggregates and lime-free admixture composition is hardened. Isoprene polymer rubbers, isoprene copolymer rubbers and SB copolymer rubbers are contemplated water repellents and DYNO-BOND is a contemplated overcoat finish in lime-free admixture compositions.

Accelerators increase the rate of early strength development and shorten the time of setting for the binder, water and lime-free admixture composition mixtures. This is important in controlling workability of these mixtures according to the environmental conditions of application of the mixtures. Lime is commonly used as an accelerator for setting up the binder in stucco (render) applications and is undesirable because of its caustic effects on breathing the powdered product. The lime-free admixture compositions of this disclosure solve this problem. Thiosulfate salts of alkali earth metal cation of Group I and II elements and ammonium cation including ammonium thiosulfate (e.g., distributed as a 60% solution by Expo Chemical Co., Inc., TX, U.S.A., manufactured by Goodpasture, Inc., TX, U.S.A.), sodium thiosulfate (e.g., manufactured by General Chemical Corp., NJ, U.S.A.), lithium thiosulfate, potassium thiosulfate, barium thiosulfate and calcium thiosulfate (e.g., BSP CAPTOR® and BSP CAPTOR® NSF which is a 30% solution of calcium thiosulfate in water, manufactured by Best Sulfur Products, Div. of AgFormulators, Inc., CA, U.S.A. and alternatively manufactured as a 24% water solution by Goodpasture, Inc., TX, U.S.A.) are suitable for use in lime-free admixture compositions. When alkali earth metal and ammonium thiosulfate salts are only commercially available as water solutions, the aqueous alkali earth thiosulfate salts are adsorbed onto finely divided calcium carbonate and the adsorbed thiosulfate salts are further dried in a convection oven so as to incorporate them as powders in lime- free admixture compositions. Calcium thiosulfate is a contemplated alkali earth metal thiosulfate accelerator ingredient in lime-free admixture compositions. Other accelerators may include a calcium salt of carboxylic acids selected from the group consisting of calcium formate (e.g. Univar, Inc. Redmond, Wash., U.S.A., Command Chemical, CT, U.S.A., manufactured by Amrut Industrial Products, Kalbadevi, Mumbai, India, Shandong Xinruida Chemical Industry Co., Ltd., Zibo, Shandong, China), calcium acetate (e.g. PHARMA RESOURCES INTERNATIONAL, Winter Park, Fla., U.S.A., manufactured by Shanghai Sungo Technology & Trade Co., Ltd., Pudong New Area, Shanghai, China, Henan Tianfu Chemical Co., Ltd., Zhengzhou, Henan, China, and calcium oxalate (e.g. INTERNATIONAL BIOLOGICAL LABORATORIES, Haryana, India, Island Pyrochemical Industries, Mineola N.Y., U.S.A.) and are suitable for use in lime-free admixture.

Alternative accelerators perform their function by providing partial cross-linking of the organic chemical components of lime-free admixture compositions of this disclosure or by providing rheological modifications. Suitable cross-linking accelerators include peroxides and azo compounds that produce free radicals that are able to react with the double bonded domains of SBS copolymer and isoprene polymer and copolymer rubbers. Examples of peroxides include dicumyl peroxide (e.g., DI-CUP 40C, manufactured by Arkema, Inc., PA, U.S.A., PERKADOX® BC-40B-GR-DD, manufactured by Akzo Nobel Polymer Chemicals, LLC, IL, U.S.A. and LUPEROX® DC99, manufactured by Atofina Chemicals, PA, U.S.A.) and benzoyl peroxide (e.g., PERKADOX® API GRANULAR, manufactured by Akzo Nobel Polymer Chemicals, LLC, IL, U.S.A. and LUPEROX® A98, as well as LUPEROX® A75, manufactured by Atofina Chemicals, PA, U.S.A.). It is understood that other peroxides including but not limited to alkyl and aryl peroxides and hydroperoxides are suitable for use as accelerators in lime-free admixture compositions. Examples of azo compounds include PERKADOX® ACCN chemically known as 1,1′-azo di(hexahydrobenzonitrile), manufactured by Akzo Nobel Polymer Chemicals, LLC, IL, U.S.A. and VA-085, chemically known as 2,2′-Azobis{2-methyl-N-[2-(1-hydroxybuthyl)]propionamide, manufactured by Wako Chemicals U.S.A., Inc., VA, U.S.A. It is understood that other azo compounds are suitable for use as accelerators for lime-free admixture compositions. Dicumyl peroxide is a contemplated cross-linking accelerator for lime-free admixturecompositions. It is understood that a cross-linking accelerator may be solely used or used in combination with a thiosulfate salt accelerator in a lime-free admixture composition.

Another type of accelerator useful in lime-free admixture compositions of this disclosure for accelerated hardening of a mixture of binder, water, aggregate and lime-free admixture composition is a buffer acidifier. In addition to the accelerator capability this ingredient is also an air-entraining agent in lime-free admixture compositions. Air-entraining agents entrain microscopic air bubbles into hydraulic cements so as to improve the durability of concrete to moisture cycles of freezing and thawing. Air-entraining agents increase the workability of fresh hydraulic cements while eliminating or reducing segregation and bleeding. An example of a suitable accelerator that is also an air-entraining agent is SUPER SPREAD® 7000, a combination of ingredients comprising aliphatic polycarboxylates, alkylaryl polyoxyethylene ethanol, butyl and isopropyl alcohol and NEODOL® 91-6 manufactured by Shell Chemicals, U.S.A. Some of the emulsifiers described supra also may function as air-entraining agents in lime-free admixture compositions.

In the U.S. Pat. No. 7,625,960 formulation the selection of the accelerator, although important, was not extremely critical because of the small amount of accelerator required to harden the mixture of hydraulic cement, a plurality of aggregates and water over the normal course of hardening a mixture. At the time, calcium thiosulfate was the preferred thiosulfate accelerator. In order to meet the guidelines of the Australian AS3700 standard, changing the formulation became necessary. In addition, there became a need to dramatically reduce the currently acceptable time of days and weeks required to cure the mixture of hydraulic cement, a plurality of aggregates and water and harden the mixture far beyond the minimum and accepted standard of compressive strength (PSI/MPA) for both mortars and stuccos (renders).

In order to accomplish the desired increase in compressive strength and reduction in curing time, a dramatic increase in the amount of accelerator was necessary. The calcium thiosulfate accelerator proved unstable and become volatile when used in the necessary increased quantities. The most striking result was that it became almost impossible to experience a controlled and similar outcome of any laboratory or field testings of the mixture. After rigorous testing and research, calcium formate was chosen to replace the calcium thiosulfate as the preferred accelerator. It proved to be very stable and constant when used in higher quantities, but reduced the “board life” of the mixture.

Cement setting times can be adjusted and board life extended with retarders. It was discovered that one or more retarders comprising salts of gluconic acids and selected from the group of gluconates consisting of magnesium, potassium, sodium and calcium, sufficiently retard a hydraulic cement, aggregate and water mixture as well as extend its “board life”. After rigorous testing, sodium gluconate became the preferred retarder because it was able to retard the mixture such that it extended the “board life” to a greater degree and was found to be more harmonious with the other admixture chemicals. It was discovered that when the amount of sodium gluconate used in a mixture of hydraulic cement, a plurality of aggregates and water was a constant 10% of the amount of the calcium formate used in that same batch mixture, the result of the application of stucco (render) or mortar, had not only a similar and controlled outcome, but a very predictable outcome as well. The curing time of the hydraulic cement mixture decreased from 28 days to 3 days and the compression strength increased by more than 125%. In short, high volumes of calcium formate used as an accelerator, when accompanied by the corresponding proportionate amount of sodium gluconate, used as a retarder, in the admixture, create the synergistic effect of a dramatically increased compressive strength (PSI/MPA) and reduction in curing time of a mixture of hydraulic cement, a plurality of aggregates and water.

Fillers may also be ingredients of lime-free admixture compositions. Fillers serve several purposes, including their ability to adsorb any liquid ingredients used in lime-free admixture compositions so as to provide lime-free admixture compositions as dry powders. Fillers also are used to control the rheology of binder, water, aggregates and lime-free admixture composition mixtures, so as to improve workability, pumping efficiency and slumping during hardening of the mixtures. Some fillers used in lime-free admixture compositions include Perlite (a naturally occurring siliceous volcanic rock that appears gray-black in its raw ore state, but puffs up like popcorn and appears white when it is quickly heated above 870 degrees Centigrade) ground to 200 mesh size, MICRO-WHITE® 100 CALCIUM CARBONATE, available from IMERYS Performance Minerals, GA., U.S.A. and diatomaceous earth (e.g. CELATOM®-MN33, manufactured by Eagle-Picher Minerals, Inc., NV, U.S.A.).

Colorants such as dyes and pigments may also be added as ingredients of lime-free admixture compositions without deteriorating the performance of binder, water, aggregates and lime-free admixture composition mixtures in unhardened and hardened form. Colorants may be used to avoid the need to paint over finished structures such as stucco (render), thereby making lime-free admixture compositions a more efficient and economical way of producing stucco (render).

A lime-free admixture comprises about 0.238 pounds (107.95 grams) to about 0.322 pounds (146.06 grams) of a sodium dodecyl benzene sulfonate emulsifier, 0.051 pounds (23.133 grams) to about 0.069 pounds (31.298 grams) of a dicumyl peroxide emulsifier, or about 0.289 pounds (131.09 grams) to about 0.391 pounds (177.35 grams) of a plurality of emulsifiers per 1600 pounds (725.748 kilograms) of hydraulic cement, about 1.012 pounds (459.04 grams) to about 1.369 pounds (620.97 grams) of a plurality of toughening resins per 1600 pounds (725.748 kilograms) of hydraulic cement emulsified by the plurality of emulsifiers and about 11.56 pounds (5.2435 kilograms) to about 15.64 pounds (7.0942 kilograms) of a plurality of accelerators per 1600 pounds (725.748 kilograms) of hydraulic cement for hardening a mixture comprising hydraulic cement, and about 1.156 pounds (524.35 grams) to about 1.564 pounds (709.42 grams) of a plurality of water retention/water reduction agents, sodium gluconate being the preferred, per 1600 pounds (725.748 kilograms) of hydraulic cement, a plurality of aggregates, water and the lime-free admixture composition. The lime-free admixture may further comprise about 0.15 pounds (68.039 grams) to about 3.2 pounds (1.451 kilograms) of a plurality of air entraining agents per 1600 pounds (725.748 kilograms) of hydraulic cement for providing microencapsulated air particles in the mixture comprising hydraulic cement, the plurality of aggregates, water and the lime-free admixture composition. Additionally, the lime-free admixture may further comprise about 2 pounds (907.18 grams) to about 4 pounds (1.814 kilograms) of a plurality of overcoat resins per 1600 pounds (725.748 kilograms) of hydraulic cement for providing a coating on an outer surface of a hardened product formed from the mixture comprising hydraulic cement, the plurality of aggregates, water and the lime-free admixture composition. The lime-free admixture may further comprise about 0.25 pounds (113.40 grams) to about 1.25 pounds (566.99 grams) of a plurality of adhesive resins per 1600 pounds (725.748 kilograms) of hydraulic cement for enhancing adhesion of the mixture comprising hydraulic cement, the plurality of aggregates, water and the lime-free admixture composition to a plurality of substrates. The lime-free admixture may further comprise less than about 4.5 pounds (2.41 kilograms) of a plurality of water retention agents per 1600 pounds (725.748 kilograms) of hydraulic cement for reducing the amount of water that is added to the mixture comprising hydraulic cement, the plurality of aggregates and the lime-free admixture composition and less than about 1.5 pounds (68.039 grams) of a plurality of pumping aids per 1600 pounds (725.748 kilograms) of hydraulic cement for providing rheological control of the mixture comprising hydraulic cement, the plurality of aggregates, water and the lime-free admixture composition.

In preferred embodiments sodium dodecyl benzene sulfonate is used to emulsify the isoprene rubber and entrain air in the mortar or stucco (render) mixture with reference to some embodiments, sodium dodecyl benzene sulfonate was reduced by 17.5% to reduce the entrained air amount in the mortar mixture in order to meet the Australian AS3700 standard.

To thwart insufficient emulsification of the isoprene rubber, dicumyl peroxide is added to the formula to aid in and complete the emulsification process of the isoprene rubber. It was discovered that the combination of dicumyl peroxide and sodium dodecyl benzene sulfonate has a synergistic effect that is greater than the effect of either sodium dodecyl benzene sulfonate or dicumyl peroxide individually. In this way, the isoprene rubber is completely emulsified and is a more controllable and stable air entrained product than before the reduction occurred and creates greater workability.

Hydroxyl ethyl methyl cellulose polymer and polyethylene oxide polymer were used in the past as pump aids. They are not preferred because they cannot be used economically as pump aids alone. It had been established that polyethylene glycol could be considered as a pumping aid. After rigorous testing and research of the many polyethylene glycol variations available in a dry powder form, it was discovered that, while a number of the polyethylene glycol variations would work in conjunction with the other chemicals in the admixture, the polyethylene glycol 3350 preformed the best. It was also discovered that guar gum could be considered as a pumping aid. It was also discovered that the combination of polyethylene glycol 3350 and guar gum had a synergistic effect that was greater than the effect of either polyethylene glycol 3350 or guar gum individually. Moreover, it was also discovered that the combination of polyethylene glycol 3350 and guar gum created a pumping aid equal to the combination of hydroxyl ethyl methyl cellulose polymer and polyethylene oxide polymer, could be purchased much more economically, were equally compatible with the other chemicals and gave greater water retention and extended board life.

Siliceous Volcanic Rock is in prior art formulas to add workability and water retention. It was eliminated completely in the preferred embodiments because it does not perform optimally. The addition of polyethylene glycol 3350 and guar gum in the formula aides in greater water retention and extended board life. The combination of the sodium dodecyl benzene sulfonate and dicumyl peroxide not only completely emulsifies the isoprene rubber but it was discovered that they completely emulsify the PAV 29, which also aides and increases water retention and extends board life as well as creates increased workability.

Sodium gluconate is added to the preferred formulas as a retarder and as a curing aid to help control the setting time and curing of the cement. Sodium Gluconate becomes a retarder because it holds large amounts of water and slows down the surface evaporation rate of the water. This added water increases the board life and water retention of the stucco (render) or mortar mixture as well.

Several different procedures may be used to dispense quantities of lime-free admixture compositions. Lime-free admixture compositions may be delivered in bulk form with a scooper having an appropriate volume to provide a correct portion of the lime-free admixture composition for each bag of hydraulic cement. Alternatively, water-soluble bags enclosing a known quantity of lime-free admixture composition may be added to the mixture of water, hydraulic cement and aggregate to make up an appropriate mixture. A further procedure involves pre-blending lime-free admixture compositions into hydraulic cement. The last procedure is not as efficient in terms of bulk shipping requirements as described supra.

The lime-free admixture compositions can be used in a method whereby a concrete-type composition that includes the admixture is applied to a building substrate. For example, a combination of the lime-free admixture composition, hydraulic cement, a plurality of aggregates and water is applied on a substrate as a masonry composition. This masonry composition can act as a finish coat on a structure. Substrates to which the masonry composition can be applied include typical construction materials for walls such as: construction block (e.g. concrete masonry unit), brick (e.g. concrete or clay), wood siding with mesh, steel surfaces with etched surfaces and mesh, concrete walls (tilt-up), sheet rock with mesh, foam board both with mesh and without mesh, and adobe walls.

In summary, lime-free admixture compositions comprise a combination of ingredients. The ingredients of the lime-free admixture compositions comprise a combination of emulsifiers, toughening resins, adhesive resins, pumping aids for providing lubrication, rheology controllers, water retention agents, water repellents, overcoat finishes, accelerators, water reducers and air entraining agents. The lime-free admixture compositions are total replacements for lime. The ingredients of the lime-free admixture compositions have specific purposes that lead to optimized properties when used in combination with a binder comprising hydraulic cement. The lime-free admixture compositions are non-corrosive, making them safe to use by workers and they have rheological properties that make them suitable for use in various applications including concrete, mortars, grouts and stucco or render.

While the invention has been particularly shown and described with reference to preferred embodiments thereof, it will be understood by those skilled in the art that the foregoing and other changes in form and details may be made therein without departing from the spirit and scope of the invention. For example, an accelerator such as a calcium salt of carboxylic acids (e.g., calcium formate, calcium acetate and calcium oxalate) may be used in lime-free admixture compositions. Colorants composed of pigments including carbon black, metal oxides (e.g., iron oxide, chromium oxide and titanium oxide) and phthalocyanine dyes may be used in lime-free admixture compositions. Emulsifiers based on a plurality of naphthalene sulfonic acid salts are also effective in lime-free admixture compositions. Various synthetic fibers including but not limited to nylons, polyesters, polyethylenes and polypropylenes and aramids, as well as glass fibers may be used as fillers and rheology controllers in lime-free admixture compositions. The rate of hardening of the mixtures of binder, water, aggregates and lime-free admixture composition may be controlled by altering the quantity of accelerators in lime-free admixture compositions and also by the use of retarders in lime-free admixture compositions.

In a further embodiment, the method for using lime-free admixture compositions may also include a step wherein a combination of the lime-free admixture composition, hydraulic cement, a plurality of aggregates and water is applied on a substrate as a masonry composition selected from the group consisting of a concrete composition, a mortar composition, a stucco (render) composition and a grout composition.

In still a further embodiment, the method for using lime-free admixture compositions may also include a step wherein a combination of the lime-free admixture composition, hydraulic cement, a plurality of aggregates and water is applied as a stucco (render) composition directly to expanded polystyrene substrates.

### Industrial/Manufacturing Setting Mixing Instructions

Each of the various raw chemicals used to create the “finished”, or “ready to market” admixture formulations disclosed herein are of varying molecular weights and densities as well as sizes and appearances. Some are granular in nature and have the consistency similar to table salt, while others may be granular in nature yet similar to table sugar. Some powdered ingredients are significantly denser than others. Some of the chemicals have a “flake” like appearance while others have a “crumb” like appearance. Due to the varying molecular weights, densities, sizes etc., the manner of blending is important to avoid “under blend” (non-homogenization) or “over mix” (separation). Non-homogenization occurs when the raw chemicals in the admixture have not been blended long enough to be completely and equally disbursed throughout the entire mix, leaving some areas of the mix with insufficient chemicals or other areas of the mix with a concentration or too much of a chemical. Separation occurs when the raw chemicals in the admixture have been blended too long, causing the heavier or denser chemicals to separate themselves from the lighter chemicals and drop towards the bottom of the blender, with the lightest of the chemicals at the bottom. The lighter chemicals tend to “float” upwards towards the top of the blender, with the lightest of the chemicals at the top. Both “under blend” (non-homogenization) and “over mix” (separation) must be avoided in order to experience the desired result.

The method of mixing the disclosed admixtures is done two different ways, depending upon the amount of finished product desired. If the desired result is an amount of finished product of 400 pounds, or less, and the chemical blender has a corresponding capacity of 10 (ten) cubic feet, 100% of all of the raw chemicals used to make the formulation can be mixed at the same time in that 10 cubic foot blender. After blending all of the chemicals for the proper amount of time, the resulting blended mixture is homogenized.

In the blending of over 400 pounds of admixture, it can be difficult to reach full homogenization of all of the raw chemicals being blended together before they begin to separate. Therefore, when mixing more than 400 pounds of finished product at a time, it is preferred to change the mixing method by mixing together in a 10 cubic foot or less blender the proper percentages of and for the appropriate amount of time, the emulsifiers, the toughening resin, the over coat resin, the air entraining agents, the adhesive resin, the pumping aid and minor water retention/water reduction agents. The combination of these raw chemicals is appropriately named “super criticals”.

The balance of the raw chemicals used to complete the formulation are the retarder, which is also the “major” water retention/water reduction agent and the accelerator. The combination of these two raw chemicals is appropriately named “non- criticals”. This blend of “super criticals” is then mixed together with the combination of the “non- criticals” in their proper weight percentages and for the appropriate amount of time in a larger than 10 cubic foot capacity blender to produce a fully homogenized mix. The larger blender's total capacity will correspond directly to the amount or weight of admixture to be mixed at any one given time.

### Field Setting Mixing Instructions for 20 Kg Cement Bag Brick, Block or Stone Mortar Mixes

Add 9 to 10 litres of clean water to mortar mixer or wheel barrow.

Add 20 kilograms of cement.

Add 150 grams of admixture in accordance with the below teachings.

Mix for one and a half minutes minimum-up to two and a half minutes if available (If in wheel barrow mixing must be aggressive and thorough).

Add 16 to 18 standard #2 shovels (approximately 5.5 kilograms per standard shovel) of washed mortar sand to mortar mixer or wheel barrow.

Mix for five minutes minimum-up to seven and one half minutes if available.

To achieve best workability additional water may be added “sparingly”.

### For 20 Kg Cement Bag Rendering Mortar Mixes

Add 9 to 10 litres of clean water to mortar mixer or wheel barrow.

Add 20 kilograms of cement.

Add 215 grams of admixture in accordance with the below teachings.

Mix for one and a half minutes minimum-up to two and a half minutes if available (If in wheel barrow mixing must be aggressive and thorough).

Add 18 to 20 standard #2 shovels (approximately 5.5 kilograms per standard shovel) of washed plaster sand to mortar mixer or wheel barrow.

Mix for five minutes minimum-up to seven and one half minutes if available.

To achieve best workability additional water may be added “sparingly”.

### For 94 Lb Cement Bag Stucco Mortar Mixes

Add 5 gallons of clean water to mortar mixer or wheel barrow.

Add 94 pounds of cement.

Add 1 pound of admixture in accordance with the below teachings. Mix for one and a half minutes minimum-up to two and a half minutes if available (If in wheel barrow mixing must be aggressive and thorough).

Add 18 to 24 standard #2 shovels (approximately 12.5 pounds per standard shovel) of washed plaster sand to mortar mixer or wheel barrow.

Mix for five minutes minimum-up to seven and one half minutes if available.

To achieve best workability additional water may be added “sparingly”.

### For 94 Lb Cement Bag Brick, Block or Stone Mortar Mixes

Add 5 gallons of clean water to mortar mixer or wheel barrow.

Add 94 pounds of cement.

Add 1 pound of admixture in accordance with the below teachings.

Mix for one and a half minutes minimum-up to two and a half minutes if available (If in wheel barrow mixing must be aggressive and thorough).

Add 22 to 28 standard #2 shovels (approximately 12.5 pounds per standard shovel) of washed mortar sand to mortar mixer or wheel barrow.

Mix for five minutes minimum-up to seven and one half minutes if available.

To achieve best workability additional water may be added “sparingly”.

Besides the formulation of chemicals, another important part of the success of the admixture is the mixing for one and a half to two and a half minutes of just the water, cement and admixture. The water starts the emulsification chain reaction of the chemicals which in turn, when emulsified, begin modifying” the cement and bringing out the special properties of increased workability and stickiness, air entraining, toughening, adhesion, pumpability, water retention/water reduction, water repellence, overcoat finish and increased PSI/MPA (strength). This note applies the same to brick, block or stone mortar as well as stucco or rendering mortar.

Although the invention has been described with reference to specific examples, it will be appreciated by those skilled in the art that the invention may be embodied in many other forms.

As used herein, unless otherwise specified the use of the ordinal adjectives “first”, “second”, “third”, etc., to describe a common object or ingredient, merely indicate that different instances of like objects are being referred to, and are not intended to imply that the objects so described must be in a given sequence, either temporally, spatially, in ranking, or in any other manner unless specified as such.

Reference throughout this specification to “one example” or “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features or ingredients of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Any claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. Features of any example or embodiment can be used in any reasonable combination.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention.

While the present invention has been disclosed with reference to particular details of construction, these should be understood as having been provided by way of example and not as limitations to the scope of the invention.

What is claimed is:

1. A lime-free admixture composition for use in hardening a mixture including the admixture composition with hydraulic cement, a plurality of aggregates and water; the admixture composition being a dry powder, the admixture composition comprising:
one or more emulsifiers, at least one emulsifier comprising a linear alkyl benzene sulfonate salt of an alkali metal cation;
one or more toughening resin, the toughening resin selected from the group consisting of isoprene polymer rubbers, isoprene copolymer rubbers, styrene/butadiene/styrene copolymer rubbers and nitrile copolymer rubbers;
one or more accelerator comprising a calcium salt of carboxylic acids selected from the group consisting of calcium formate, calcium acetate and calcium oxalate; and
one or more retarder comprising a salt of gluconic acids selected from the group of gluconates consisting of magnesium, potassium, sodium and calcium.

2. A lime-free admixture composition for use in hardening a mixture including the admixture composition with hydraulic cement, a plurality of aggregates and water; the admixture composition being a dry powder; the admixture composition comprising:
one or more emulsifiers, at least one emulsifier comprising dicumyl peroxide;
one or more toughening resin, at least one toughening resin selected from the group consisting of isoprene polymer rubbers, isoprene copolymer rubbers, styrene/butadiene/styrene copolymer rubbers and nitrile copolymer rubbers;
one or more accelerator comprising a calcium salt of carboxylic acids selected from the group consisting of calcium formate, calcium acetate and calcium oxalate; and
one or more retarder comprising a salt of gluconic acids selected from the group of gluconates consisting of magnesium, potassium, sodium and calcium.

3. The admixture composition according to claim 1, wherein the emulsifiers are a linear alkyl benzene sulfonate salt of sodium dodecyl benzene sulfonate and dicumyl peroxide.

4. The admixture composition according to either of claim 1 or 2, further comprising:
at least one overcoat resin; the overcoat resin comprises a combination of latex polyvinyl acetate polymers and copolymers;
wherein one overcoat resin provides a coating on an outer surface of a hardened product formed from the mixture.

5. The admixture composition according to claim 4, wherein the emulsifier comprises a linear alkyl benzene sulfonate salt of sodium dodecyl benzene sulfonate and dicumyl peroxide.

6. The admixture composition according to either of claim 1 or 2 further comprising hydraulic cement, the composition being in a dry powder form, such that for each 1600 pounds (725.748 kilograms) of hydraulic cement the composition comprises a blend of:
0.289 pounds (131.09 grams) to 0.391 pounds (177.35 grams) of the one or more emulsifier;
1.012 pounds (459.04 grams) to 1.369 pounds (620.97 grams) of the one or more toughening resin;
11.56 pounds (5.2435 kilograms) to 15.64 pounds (7.0942 kilograms) of the one or more accelerator; and
1.156 pounds (524.35 grams) to about 1.564 pounds (709.42 grams) of one or more water retention/water reduction agents.

7. The composition according to claim 6, the blend further comprising:
0.15 pounds (68.039 grams) to about 3.2 pounds (1.451 kilograms) of at least one air entraining agent, the air entraining agent selected from the group consisting of aliphatic polycarboxylates, alkylaryl polyoxyethylene ethanol, butyl and isopropyl alcohol, a linear alkyl benzene sulfonate salt of an alkali metal cation, a linear alkyl benzene sulfonate salt of a non-metal cation;
wherein the air entraining agent provides microencapsulated air particles in the mixture.

8. The composition according to claim 6, the blend further comprising:
2.0 pounds (907.18 grams) to about 4.0 pounds (1.814 kilograms) of at least one overcoat resin, the overcoat resin comprising a combination of latex polyvinyl acetate polymers and copolymers; the overcoat resin providing a coating on an outer surface of a hardened product formed from the mixture.

9. The composition according to claim 6, the blend further comprising:
0.25 pounds (113.40 grams) to about 1.25 pounds (566.99 grams) of at least one adhesive resin for enhancing adhesion of the mixture, the adhesive resin selected from the group consisting of isoprene polymer rubbers, isoprene copolymer rubbers, styrene-butadiene-styrene copolymer rubbers, nitrile copolymer rubbers, vinyl acetate/vinyl versatate copolymers, ethyl vinyl acetate copolymer, polyvinyl acetate polymers and polyvinyl acetate copolymers.

10. The composition according to claim 6, the blend further comprising:
less than about 4.5 pounds (2.41 kilograms) of at least one water retention agent for reducing the amount of water that is added to the mixture, the water retention agent selected from the group consisting of isoprene polymer rubbers, isoprene copolymer rubbers, styrene-butadiene copolymer rubbers, polyvinyl acetate/vinyl versatate copolymers, polyethylene glycol polymers, polyethylene glycol copolymers, polyacrylamide polymers, polyacrylamide copolymers, xanthan gums and guar gums; and
less than about 1.5 pounds (68.039 grams) of at least one pumping aid for providing rheological control of the mixture, the pumping aid being selected from the group consisting of polyethylene glycol polymers, polyethylene glycol copolymers, polyacrylamide polymers, polyacrylamide copolymers, xanthan gums, guar gums.

11. The composition according to claim 6, wherein the alkali earth metal cation is an alkali earth metal cation selected from the group consisting of lithium, sodium, potassium, magnesium and calcium.

12. The composition according to claim 11, wherein the water redispersible polymer is a redispersible polymer selected from the group consisting of vinyl acetate/vinyl versatate copolymers, ethyl vinyl acetate copolymers, polyvinyl acetate polymers and polyvinyl acetate copolymers.

13. The admixture composition in accordance with either of claim 1 or 2 and further comprising:
a hydraulic cement, a plurality of aggregates and water mixed with the admixture, that is applied as a stucco (render) composition directly to an expanded polystyrene substrate.

14. A method of blending an admixture, comprising the steps of:
pre-mixing together in first blender of about a 10 cubic foot or less, a first mixture of one or more emulsifiers, one or more toughening resins, an over coat resin, one or more air entraining agents, an adhesive resin; and
mixing together a second mixture of water retention and an accelerator; then blending together the first and second mixtures in a second blender that is larger than the first blender to achieve a homogenized mix.

15. The method of claim 14, wherein:
the first mixture further comprises water retention or water reduction agents.

16. The method of claim 14, wherein:
the first mixture further comprises a pumping aid.
